(19) United States
(12) Patent Application Publication
(10) Pub. No.: US 2022/0184832 A1
(43) Pub. Date: Jun. 16, 2022

(54) Hair Clipper with Tapered Rectangular Handle

(71) Applicants: Edwin A. Werner, Union Grove, WI (US); Jake Schilling, Racine, WI (US); Evan A. Sparks, Cottage Grove, WI (US)

(72) Inventors: Edwin A. Werner, Union Grove, WI (US); Jake Schilling, Racine, WI (US); Evan A. Sparks, Cottage Grove, WI (US)

(21) Appl. No.: 17/318,676

(22) Filed: May 12, 2021

Related U.S. Application Data
(63) Continuation-in-part of application No. 29/761,651, filed on Dec. 10, 2020.

(51) Int. Cl. B26B 19/38; B26B 19/12

(52) U.S. Cl. CPC B26B 19/3853; B26B 19/3886; B26B 19/3873; B26B 19/12

(57) ABSTRACT

A haircutter handle is described that has upper and lower housings. The upper housing and lower housing join to form a pliable exterior surface. The handle narrows/tapers as it extends axially from a blade end to a gripping end opposite the blade. The blade has an upper oscillatory blade that oscillates over a stationary lower blade to cut hair. The handle's taper facilitates grasping by locating the motor and battery so that the center of gravity is located within the palm of the user's hand. The width and/or height at the blade end is greater than at the handle or grip end, and the reduction in height and/or width dimensions define the taper to locate the user's hand relative to the center of gravity. In some embodiments, the width tapers more than the height tapers to facilitate gripping handle about the center of gravity.

### CROSS-REFERENCE TO RELATED PATENT APPLICATION

This application is a Continuation-in-Part of U.S. Design application No. 29/761,651, filed Dec. 10, 2020, which is incorporated herein by reference in its entirety.

### BACKGROUND OF THE INVENTION

The present invention relates generally to the field of haircutters or clippers. The present invention relates specifically to hair clippers with a modified balanced housing.

### SUMMARY OF THE INVENTION

One embodiment of the invention relates to a haircutter having a blade assembly and a handle. The blade assembly defines a cutting end with a stationary blade and an oscillating blade that oscillates cutting teeth over the stationary blade to cut hair. The handle has a rectangular base at a gripping end opposite the blade assembly. The user grasps the gripping end to operate the haircutter. The handle defines a height taper and a width taper. The reduction from a maximum height of the handle to a base height defines the height taper. The reduction from a maximum width of the handle to a base width defines the width taper. The width taper is greater than the height taper, such that the handle width reduces more than the handle height.

Another embodiment of the invention relates to a haircutter having a handle coupled to a blade assembly. The handle having a first end defining a first width and a first height. Similarly, a second end opposite the first end defines a second width and a second height. The handle has a taper, such that the first width and first height are greater than the second width and second height. The handle further includes a rectangular base with a first base width and a first base height. The blade assembly is coupled to the handle at the first end and includes a first blade and a second blade. The first blade having oscillating teeth extending along a first blade edge. The second blade having teeth extending along a second blade edge that is orientated parallel to the first blade edge. A distance between the first and second blade edges defines a blade gap. A side lever is coupled to the first blade to move the first blade edge relative to the second blade edge adjusting the blade gap. Increasing or decreasing the blade gap adjusts the length of hair cut by the blade assembly.

Another embodiment of the invention relates to a haircutter having a clamshell handle coupled to a blade assembly. The clamshell handle has an upper housing and a lower housing that extend axially between a cutting end and a rectangular base at a gripping end opposite the cutting end. The upper housing includes a hair shield defined by an upward sloped portion proximate the cutting end such that hair is deflected away from the blade assembly. The lower housing is coupled to the upper housing forming a recessed perimeter between the upper and lower housing. The recessed perimeter includes a switch. The upper and lower housing together define a tapered handle having a width at the cutting end that is greater than a width at the base. The reduction of the handle width defines a width taper. Similarly, a height at the cutting end is greater than a height at the base. The reduction of the handle height defines a height taper. The width taper of the handle is greater than the height taper. The blade assembly is coupled to the cutting end of the handle and includes a first blade and a second blade. The first blade having oscillating teeth extending along a first blade edge. The second blade having teeth extending along a second blade edge that is orientated parallel to the first blade edge. A distance between the first and second blade edges defines a blade gap. A lever is coupled to the first blade to move the first blade edge relative to the second blade edge adjusting the blade gap. Increasing or decreasing the blade gap adjusts the length of hair cut by the blade assembly.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a top perspective view of a hair clipper, according to an exemplary embodiment.

FIG. 2 is a bottom perspective view of the hair clipper of FIG. 1.

FIG. 3 is a front side view of the hair clipper of FIG. 1.

FIG. 4 is a rear side view of the hair clipper of FIG. 1.

FIG. 5 is a right side view of the hair clipper of FIG. 1.

FIG. 6 is a left side view of the hair clipper of FIG. 1.

FIG. 7 is a top side view of the hair clipper of FIG. 1.

FIG. 8 is a bottom side view of the hair clipper of FIG. 1.

FIG. 9 is a cross-sectional view of the hair clipper of FIG. 1.

### DETAILED DESCRIPTION

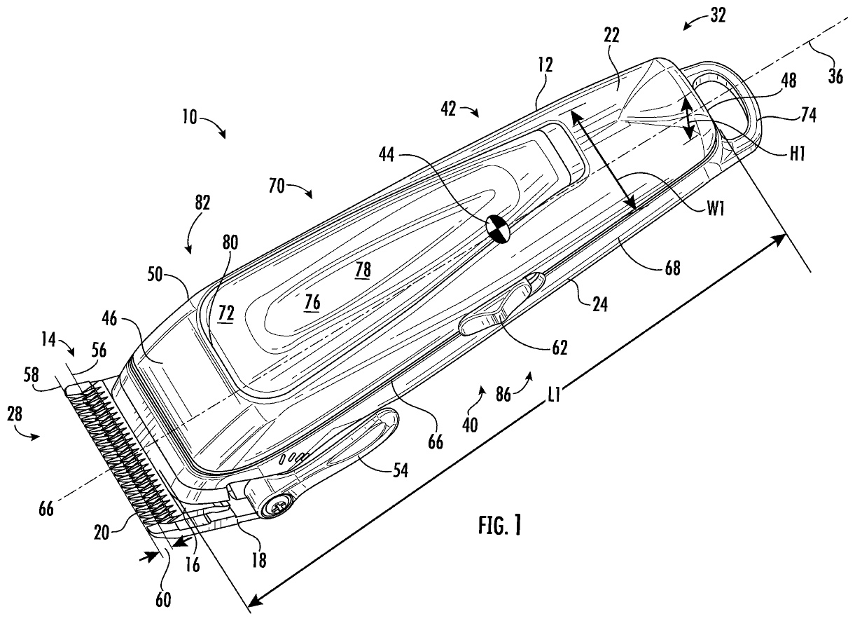

Referring to FIG. 1, a hair trimmer, clipper, or clipper 10 is shown. Clipper 10 has a handle 12 and a blade assembly 14. Blade assembly 14 includes a cutting upper blade or cutter 16 and a stationary outer or lower blade 18. Oscillating blade/cutter 16 and stationary blade 18 of blade assembly 14 cooperate to cut hair as teeth 20 of cutter 16 oscillate over teeth 20 on stationary blade 18. Specifically, as cutter 16 oscillates over stationary blade 18, the teeth 20 on cutter 16 and blade 18 capture hair follicles and cooperate to cut hair.

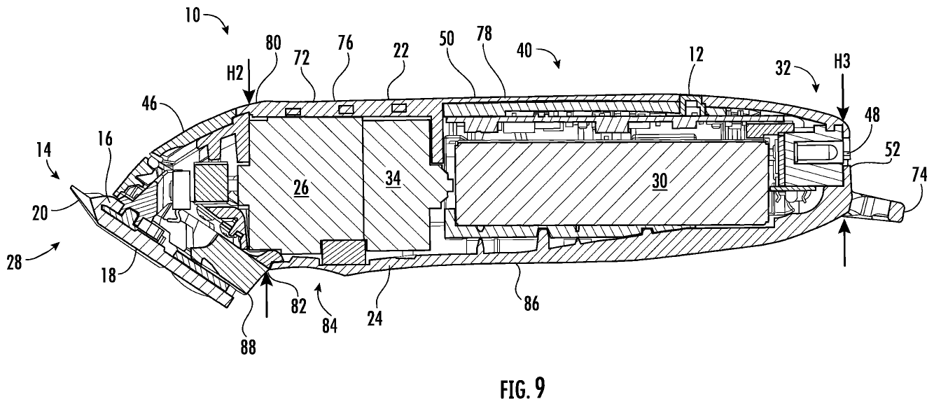

FIG. 1 shows a clamshell handle 12 with an upper housing 22 and a lower housing 24. Applicant has found that reducing (e.g., tapering) height/width dimensions on handle 12 (e.g., along the upper and lower housings 22 and 24) enhances the balance of the clipper 10, for example, by balancing components in handle 12 to blade assembly 14. Specifically as shown in FIG. 9, the weight of the blade assembly 14 and a motor 26 are coupled near the cutting side or cutting end 28 of handle 12. The weight of motor 26 and blade assembly 14 is offset or balanced in handle 12 by the counterweight provided by a battery 30 at the tapered gripping end 32 of handle 12. Specifically, reducing or tapering the width W1 and/or height H1 dimensions of clipper 10 enables the motor 26 to be housed within an internal cavity 34 near cutting end 28, and an elongated battery 30 is captured within internal cavity 34 near the gripping end 32. For example, the width W3 and/or the height H3 at gripping end 32 is less than the maximum width W2 and/or maximum height H2 at cutting end 28. As used herein, H1 and W1 are used generally to denote a height direction or width direction generally.

Handle 12 extends along a longitudinal or axial axis 36 that extends from a blade end or cutting end 28 to a handle end or gripping end 32 to define a housing length L1. At an orthogonal or perpendicular angle to axial axis 36, a housing width W1 (e.g., between left and right sides of handle 12) and a housing height H1 (e.g., between the top and bottom sides of handle) are defined. Applicant has found that by including a height taper 40 and a width taper 42, or specifically a reduction in height H1 and width W1 dimensions along axial axis 36, a center of gravity 44 for the clipper 10 is more comfortably located within a user's grasp and the size of hair shield 46 is maximized to enhance protection of cavity 34 within handle 12.

Handle 12 has width W1 and height H1 dimensions extending orthogonally from axial axis 36. In various embodiments, handle 12 extends in an arched and/or linear direction along width W1 and/or height H1 dimensions, such that at different locations along axial axis 36, the width W1 and/or height H1, measured in a transverse direction to axial axis 36, is tapered between cutting end 28 and a rectangular base 48 at gripping end 32.

Handle 12 extends between a cutting end 28 and a base 48 at a gripping end 32 of handle 12. A height taper 40 and a width taper 42 measure the relative change between the maximum height H2 and maximum width W2 near the cutting end 28 to a base height H3 and base width W3 at the base 48 of gripping end 32. Specifically, the height taper 40 is a dimensionless number that represents a comparison of the height H1 of handle 12 near the gripping end 32 (e.g., base height H3) divided by the maximum height H2 of handle 12. Similarly, the width taper 42 is a dimensionless number that represents a comparison of the width W1 of handle 12 at the gripping end 32 (e.g., base width W3) divided by the maximum width W2 of handle 12. In various embodiments, rectangular base 48 has base width W3 between 1 inch and 1.2 inches, specifically between 1.05 inches and 1.15 inches, and a base height between 0.8 inches and 1 inch, specifically between 0.85 inches and 0.95 inches.

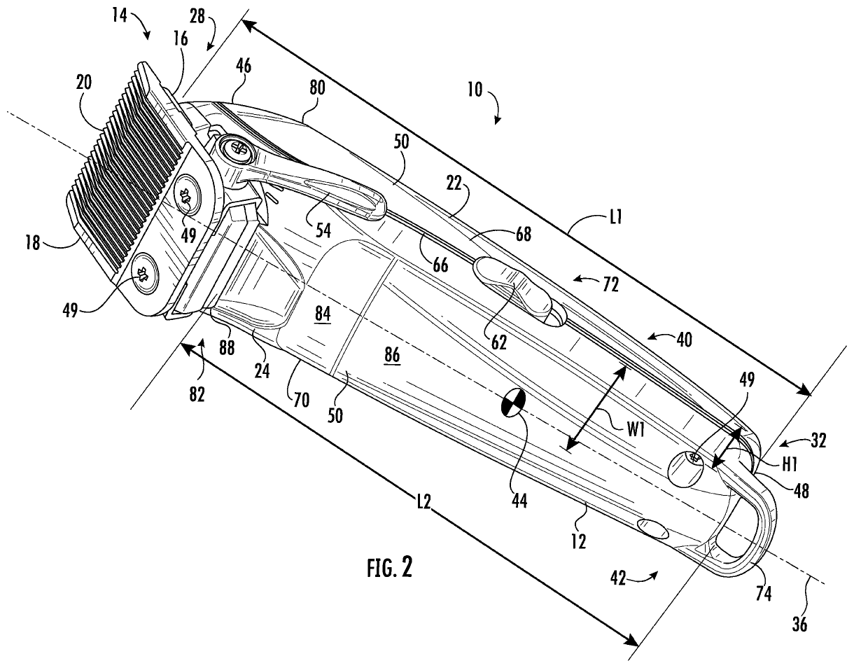

In various embodiments, handle 12 is a single, continuous, and/or integral part, such that upper housing 22 and lower housing 24 are permanently joined and/or fabricated as an integral continuous component or unitary part. In other embodiments, upper housing 22 is fabricated separately from lower housing 24 and joined or coupled to form handle 12, e.g., using fasteners 49 (FIG. 2). A hair shield 46 is formed on the exterior surface 50 of upper housing 22. Hair shield 46 prevents cut hair or other debris from entering an internal cavity 34 and interfering with rotary motor 26 (FIG. 9). Hair shield 46 captures and/or deflects hair and other debris away from the internal cavity 34 formed by handle 12 and housing rotary motor 26. For example, a rotary motor 26 is captured behind blade assembly 14 at the cutting end 28 between the upper housing 22 and the lower housing 24. At the opposite end, or handle gripping end 32, a charging port 52 electronically couples to battery 30 within internal cavity 34. Electric charging port 52 is located on a base 48 of handle 12 (e.g., on gripping end 32) and is electronically coupled to battery 30 located in gripping end 32 and captured between upper housing 22 and lower housing 24.

In one embodiment, a side lever 54 is coupled to cutter 16, and lever 54 rotates to translate cutter blade edge 56 relative to lower/stationary blade edge 58 to increase or decrease a blade gap 60. Rotation of lever 54 changes blade gap 60 between blade edges 56 and 58 in a transverse orthogonal direction by moving cutter 16 a transverse distance. Blade gap 60 changes a thickness T1 of lower blade 18 that cuts hair. For example, when blade gap 60 is small, teeth 20 of cutter 16 generally align with teeth 20 on lower blade 18, and clipper 10 cuts a shorter length of hair than when blade gap 60 is large or increased. Specifically, when the blade gap 60 is large, the complete thickness T1 of lower blade 18 is utilized to create a minimum hair length. In this way, lever 54 controls the length of the hair cut by hair clipper 10.

As shown in FIGS. 1 and 2, a sliding power switch 62 powers clipper 10 and is captured in a recessed perimeter 66 formed between upper housing 22 and lower housing 24. In various embodiments, recessed perimeter 66 defines a slot or depth between upper housing 22 and lower housing 24 between 0.025 inches and 0.1 inches, specifically between 0.04 inches and 0.08 inches, and more specifically between 0.05 inches and 0.075 inches. Recessed perimeter 66 extends around base 48, left side 68, right side 70, and top side 72 near cutting end 28 of handle 12. In various embodiments, recessed perimeter 66 has a length of between 13 inches and 15 inches, specifically, between 13.5 inches and 14.5 inches, and more specifically between 13.75 inches and 14.25 inches.

Side switch 62 is captured between upper housing 22 and lower housing 24 and operates to power cutter 16 on and off. In various embodiments, switch 62, upper housing 22, and/or lower housing 24 are each fabricated from a different material.

A hook 74 is located on handle 12 near base 48. Hook 74 is located on lower housing 24 and facilitates hanging, storing, and/or gripping handle 12. In various embodiments, hook 74 extends between 0.25 inches to 0.5 inches, specifically between 0.3 inches and 0.4 inches, away from base 48 in the direction of axial axis 36. Hair clipper 10 includes enclosed hook 74 extending from either side (e.g., left side 68 and right side 70) of base 48 on handle 12. In various embodiments, enclosed hook 74 has a width W1 dimension equal to or greater than 90%, specifically 95%, and more specifically 99%, or more of handle 12 base width W3. In one embodiment, base width W3 of handle 12 is equal to width W1 of hook 74.

In various embodiments, upper housing 22 includes a recess or depression 76 on a top surface or top side 72 of handle 12. Depression 76 forms a gripping pad 78 for a user to place a thumb or fingers while holding handle 12. Depression 76 extends along top side 72 of handle 12 to a projection 80 that defines a maximum height H2 of handle 12. In various embodiments, depression 76 is measured from projection 80 to gripping surface or pad 78 and is between 0.025 inches and 0.1 inches, specifically between 0.06 inches and 0.09 inches, and more specifically, between 0.07 inches and 0.08 inches, in a height H1 direction on handle 12.

Lower housing 24 includes a neck 82 forming a neck gripping recess 84 on a bottom surface or bottom side 86 of handle 12 configured for a user's finger. Finger gripping recess 84 receives the user's finger about neck 82 of blade assembly 14. A gripping depression pad 78 can be located in depression 76 and/or recess 84 of upper housing 22 and/or lower housing 24. For example, neck 82 and/or gripping depression 76 and/or recess 84 are fabricated from a dip molded polymer material.

FIG. 2 shows a bottom perspective view of hair clipper 10. From this perspective, height taper 40 and width taper 42 are shown extending away from blade assembly 14. Blade assembly 14 is coupled to lower housing 24 and extends angularly along lower housing 24. Stated differently, upper housing 22 extends further in the axial direction than lower housing 24 to create an angled recess 84 in lower housing to capture and/or couple lower housing 24 of handle 12 to blade assembly 14

Blade 18 is coupled to handle 12 (e.g., upper/lower housing 22 and/or 24) and stationary or static. In contrast, cutter 16 oscillates in a direction parallel to blade edges 56 and 58 (e.g., in a direction parallel to the width W1 of handle 12). As described in greater detail below, a lever 54 is coupled to cutter 16 to translate cutter 16 along in a direction parallel to axial axis 36 to change a gap 60 between cutter 16 and blade 18. For example, changing the gap 60 between upper and lower blade edges 56 and 58 changes the length of hair that is cut by cutter 16. Specifically, a shorter gap 60 between the blade edges 56 and 58 enables the combined thicknesses of the cutter 16 and blade 18 to create a longer cut length. Similarly, a longer gap 60 between the blade edges 56 and 58 reduces the combined thickness between the blades and creates a shorter cut length.

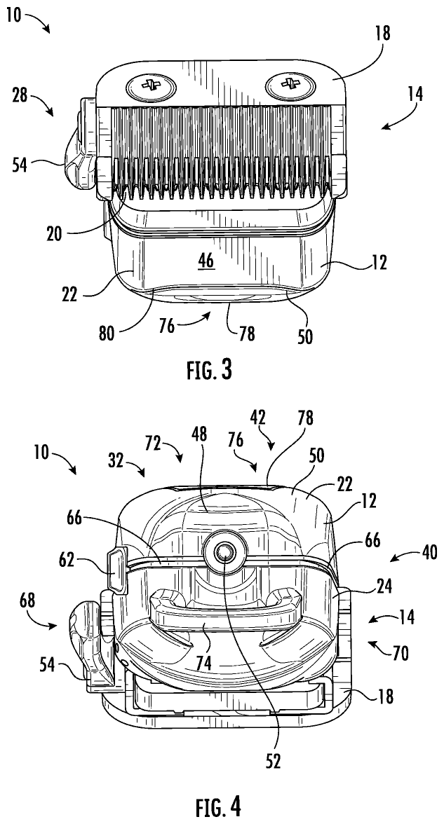

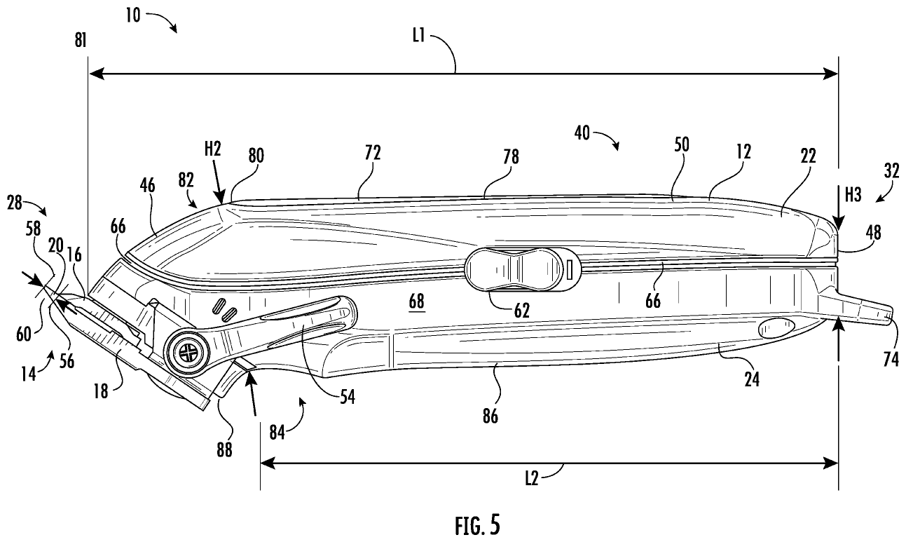

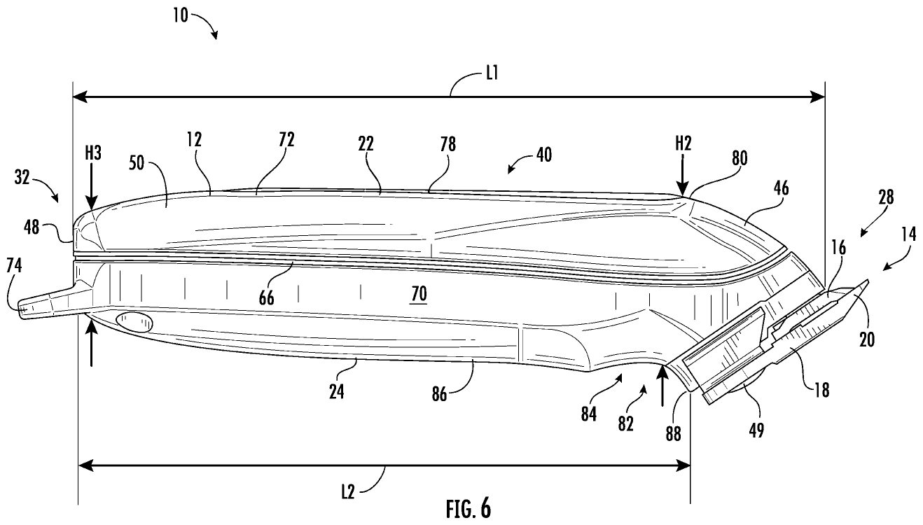

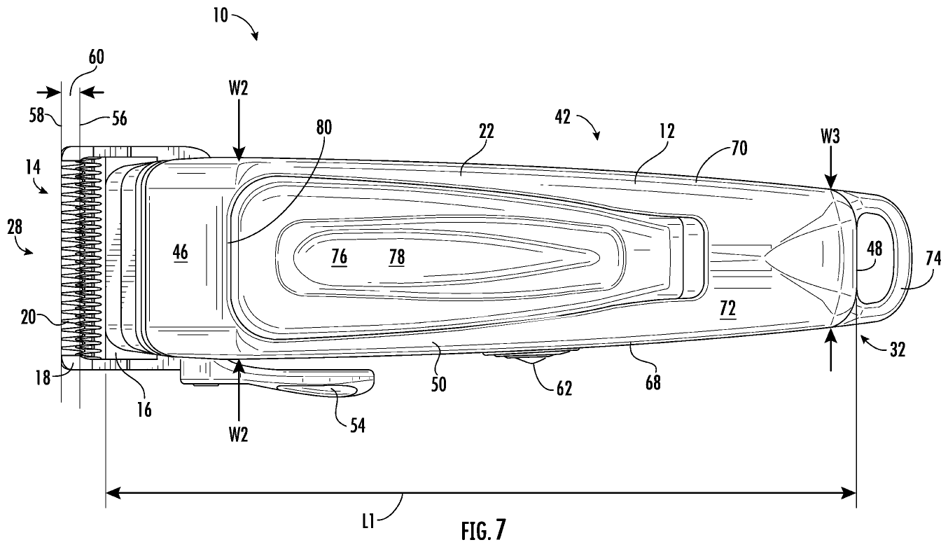

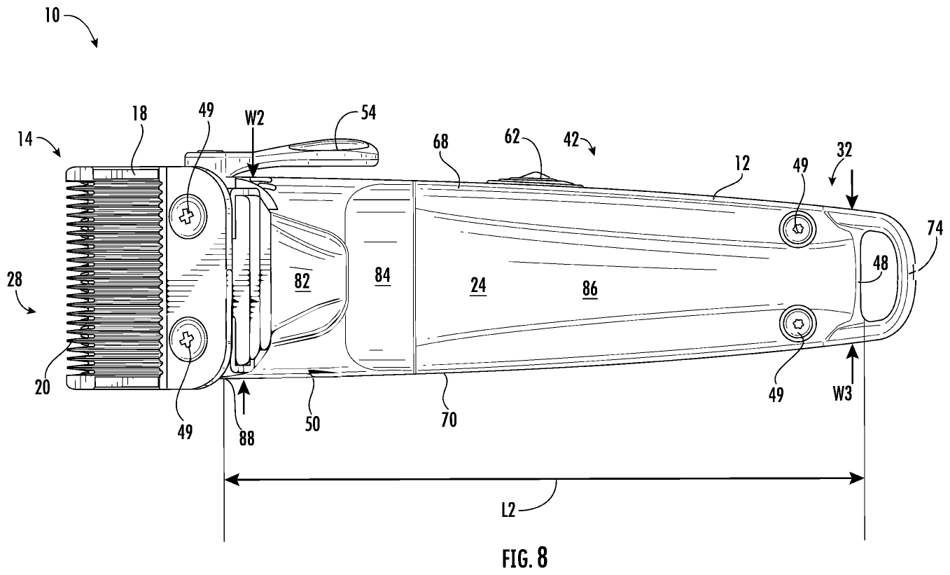

FIGS. 3-9 illustrate different orthogonal views of hair clipper 10 and demonstrate relative and absolute dimensions of clipper 10 to illustrate the shape of height and width tapers 40 and 42 and relationship of handle 12 relative to blade assembly 14. A handle length L1 is measured along axial axis 36 and defined from a base 48 of handle 12 at the gripping end 32 to a distal end 81 of projection 80 at cutting end 28. Similarly, a lower housing length L2 is defined along axial axis 36 from base 48 to a bend 88 at cutting end 28 to couple blade assembly 14 to handle 12. In various embodiments, handle length L1 is between 5 inches and 7 inches, specifically, between 5.5 inches and 6.5 inches, and more specifically, between 5.75 inches and 6.25 inches. In various embodiments, lower housing length L2 is between 4 inches and 5.5 inches, specifically between 4.5 inches and 5 inches. In one embodiment, lower housing length L2 is 4.75+/−0.05 inches.

Similarly, a handle height H1 is defined in an orthogonal direction to axial axis 36 between a top surface or side 72 and a bottom surface or side 86 of handle 12. A height taper 40 measures the relative change between the maximum height H2 (near the cutting end 28) and the base height H3 (e.g., measured at the gripping end 32). In one embodiment, height taper 40 is a linear height taper 40 between maximum height H2 and base height H3. In various embodiments, maximum height H2 is between 1.0 inches and 1.5 inches, specifically, between 1.2 inches and 1.4 inches, and more specifically, between 1.25 inches and 1.35 inches. In various embodiments, base height H3 is between 0.5 inches and 1 inch, specifically, between 0.6 inches and 0.9 inches, and more specifically between 0.7 inches and 0.8 inches.

Height taper 40 is a relative comparison of maximum height H2 and base height H3. Height taper 40 is defined as the reduction ratio or percentage of maximum height H2 to achieve base height H3. As a specific example, when maximum height H2 is 1.3 inches, and base height H3 is 0.8 inches, height taper 40 is 0.8/1.3 inches (e.g., 0.8:1.3 inches) or approximately 61.5%. In various embodiments, the maximum height H2 is between 1.2 inches and 1.4 inches, and base height H3 is between 0.7 inches and 0.9 inches, such that height taper 40 is between 58% and 62%. In various embodiments, base height H3 is between 65% and 75% of base width W3, specifically, between 67% and 73%, and more specifically between 69% and 71%.

Similarly, a handle width W1 is defined in an orthogonal direction to axial axis 36 between a left surface or side 68 and a right surface or side 70 of handle 12. A width taper 42 measures the relative change between the maximum width W2 (near the cutting end 28) and the base width W3 (e.g., measured at the gripping end 32). In one embodiment, width taper 42 is a linear width taper 42 between maximum width W2 and base width W3. In various embodiments, maximum width W2 is between 1.3 inches and 1.8 inches, specifically, between 1.4 inches and 1.7 inches, and more specifically, between 1.5 inches and 1.6 inches. In various embodiments, base width W3 is between 0.9 inches and 1.3 inches, specifically between 1.0 inch and 1.2 inches, and more specifically between 1.05 inches and 1.15 inches.

Width taper 42 is a relative comparison of maximum width W2 and base width W3. Width taper 42 is defined as the reduction ratio or percentage of maximum width W2 to achieve base width W3. As a specific example, when maximum width W2 is 1.6 inches and base width W3 is 1.1 inches, width taper 42 is 1.1/1.6 in/in (e.g., 1.1:1.6 in/in) or approximately 68.75%. Compared to the previous height example with a height taper 40 of 61.5%, the width taper 42 of 68.75% is greater than the 61.5% height reduction. In other words, the reduction of width taper 42 is greater than the reduction of height taper 40. In various embodiments, maximum width W2 is between 1.5 inches and 1.7 inches, and base width W3 is between 1.0 and 1.2 inches, such that width taper is between 70% and 76%.

When width taper 42 is linear, an angle measure of width taper 42 is made by comparing the angle formed between left side 68 and right side 70 of handle 12. In various embodiments, width taper 42 is between 7° and 11°, specifically, between 8° and 10°. In a specific embodiment, the width taper 42 defines a 9.4° angle (+/−0.1°).

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes, and omissions may also be made in the design, operating conditions, and arrangement of the various exemplary embodiments without departing from the present invention's scope.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

In various exemplary embodiments, the relative dimensions, including angles, lengths, and radii, are to scale as shown in the Figures. The figures' actual measurements will disclose relative dimensions, angles, and proportions of the various exemplary embodiments. Various exemplary embodiments extend to various ranges around the absolute and relative dimensions, angles, and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description. In addition, in various embodiments, the present disclosure extends to a variety of ranges (e.g., plus or minus 30%, 20%, or 10%) around any of the absolute or relative dimensions disclosed herein or determinable from the Figures.

What is claimed is:

1. A haircutter, comprising:
a blade assembly at a cutting end having a stationary blade and an oscillating blade that oscillates cutting teeth over the stationary blade to cut hair; and
a handle defining a rectangular base at a handle end opposite the blade assembly at the cutting end and an axial axis extending longitudinally through the handle from the base to the cutting end, wherein a base height is between 65% and 75% of a base width;
wherein the handle defines a height taper and a width taper relative to the axial axis, wherein the height taper is a reduction of a maximum height of the handle to the base height, and the width taper is the reduction of a maximum width of the handle to the base width measured at the base; and
wherein the width taper is greater than the height taper.

2. The haircutter of claim 1, wherein the maximum width is between 1.5 inches and 1.7 inches and a width at the handle end is between 1.0 inch and 1.2 inches, and wherein the width taper is between 70% and 76%.

3. The haircutter of claim 1, wherein the width taper is between 7° and 11°.

4. The haircutter of claim 1, wherein the maximum height is between 1.2 inches and 1.4 inches and a height at the handle end is between 0.7 inches and 0.9 inches, and wherein the height taper is between 58% and 62%.

5. The haircutter of claim 1, further comprising a rotary motor, wherein the rotary motor and the blade assembly are captured behind the blade assembly and within the handle opposite the base.

6. The haircutter of claim 1, further comprising an electric charging port and a battery, wherein the electric charging port is located at the handle end and is electronically coupled to the battery captured within the handle at the base.

7. The haircutter of claim 1, further comprising a side switch that is captured within the handle, including a clamshell formed by an upper housing and a lower housing, wherein the upper housing and the lower housing are each fabricated from a different material.

8. The haircutter of claim 1, further comprising an upper housing and a lower housing of the handle, wherein the upper housing includes a depression substantially parallel to the axial axis with a gripping pad, wherein the upper housing further includes a hair shield defined by an upward sloped portion at the cutting end such that the hair shield deflects hair away from the blade assembly, and wherein the lower housing includes a neck that extends in a substantially perpendicular direction to the axial axis with a finger gripping recess that receives a finger of a user about the neck of the blade assembly.

9. The haircutter of claim 8, wherein the gripping depression pad on the upper housing and the neck gripping recess are each fabricated from a dip molded polymer material.

10. A haircutter, comprising:
a handle, having:
a first end having a first width and a first height;
a second end opposite the first end, the second end having a second width and a second height, wherein the first width and the first height are greater than the second width and the second height; and
a rectangular base having a base width between 1 inch and 1.2 inches and a base height between 0.8 inches and 1 inch; and
a blade assembly, having:
a first blade having teeth extending along a first blade edge and oscillating parallel to the first blade edge;
a second blade having teeth extending along a second blade edge parallel to the first blade edge defines a blade gap between the first blade edge and the second blade edge; and
a side lever coupled to the first blade, wherein the side lever rotation translates the first blade edge relative to the second blade edge to increase or decrease the blade gap.

11. The haircutter of claim 10, wherein the handle is an integral continuous component.

12. The haircutter of claim 10, further comprising a depression on a top surface of the handle substantially parallel to an axial axis, wherein the axial axis extends longitudinally through the handle from the second end to the first end, the depression configured to receive a user's thumb to grip the handle.

13. The haircutter of claim 12, wherein the depression extends along the top surface of the handle to a projection at a maximum height of the handle.

14. The haircutter of claim 13, wherein the depression is between 0.025 inches and 0.1 inches in the height direction measured from the projection on the handle.

15. The haircutter of claim 10, further comprising an upper housing coupled to a lower housing, wherein a recessed perimeter between the upper housing and the lower housing has a depth of between 0.025 inches and 0.1 inches.

16. The haircutter of claim 15, further comprising a hook on the lower housing extending between 0.25 inches to 0.5 inches along an axial axis of the haircutter from a base of the handle and having a width dimension equal to 90% or more of a handle width at the base.

17. The haircutter of claim 16, further comprising a sliding power switch in the recessed perimeter, wherein the recessed perimeter has a length of between 13 inches and 15 inches

18. A haircutter, comprising:
a clamshell handle, having:
an upper housing extending axially between a cutting end and a rectangular base at a gripping end opposite the cutting end, wherein the upper housing includes a hair shield defined by an upward sloped portion at the cutting end such that the hair shield deflects hair away from the blade assembly; and
a lower housing coupled to the upper housing and forming a recessed perimeter, the lower housing extending axially between the cutting end and the base; and
a switch in the recessed perimeter between the upper housing and the lower housing;
wherein the upper housing and the lower housing define a tapered handle having a width at the cutting end that is greater than a width at the base, and wherein the upper housing and the lower housing define a width taper having a height at the cutting end that is greater than a height at the base, wherein the height taper is a dimensionless number representing a height of handle at the gripping end divided by a maximum height of the handle, wherein the width taper is a dimensionless number representing a width of the handle at the gripping end divided by a maximum width of the handle, and wherein the width taper is greater than the height taper; and
a blade assembly coupled to the cutting end, the blade assembly having:
a cutter blade having teeth extending along a cutter blade edge defining a first direction, the cutter blade configured to oscillate in the first direction;
a stationary blade having teeth extending along a stationary blade edge that is parallel to the cutter blade edge, wherein a transverse distance between the cutter blade edge and the stationary blade edge defines a blade gap; and
a lever coupled to the first blade, wherein moving the lever translates the first blade in a transverse orthogonal direction to the first direction of the cutter blade edge and the stationary blade edge to increase or decrease the blade gap.

19. The haircutter of claim 18, further comprising a charging port and a battery captured within the clamshell handle, wherein the charging port is located in the base, and the battery is located nearer to the gripping end than the cutting end, and wherein the width at the cutting end and the height at the cutting end is less than the maximum width and the maximum height, respectively.

20. The haircutter of claim 19, further comprising a motor captured within the clamshell handle between the upper housing and the lower housing, wherein the motor is located nearer to the blade assembly at the cutting end than the base at the tapered gripping end.
